(19) United States
(12) Patent Application Publication
(10) Pub. No.: US 2002/0062431 A1
(43) Pub. Date: May 23, 2002

(54) Method and device for processing data in a memory unit

(76) Inventors: Alexander Benedix, Munchen (DE); Bernd Klehn, Munchen (DE); Georg Braun, Munchen (DE)

Correspondence Address: LERNER AND GREENBERG, P.A., POST OFFICE BOX 2480, HOLLYWOOD, FL, 33022-2480, US

(21) Appl. No.: 09/910,748

(22) Filed: Jul. 23, 2001

(30) Foreign Application Priority Data
Jul. 21, 2000 (DE) 100 35 635.4

(51) Int. Cl. G06F 12/00

(52) U.S. Cl. 711/202; 711/167

(57) ABSTRACT

Data in a memory unit are processed with one of a variety of access strategies. Parallel to the execution of a task according to a first access strategy, the time is calculated that would be required for the processing of the task according to a second access strategy. If the second access strategy is faster than the first access strategy, in the future the second access strategy is used for the execution of that task. In this way, a faster data access, adapted to various tasks, is achieved.

### BACKGROUND OF THE INVENTION

### Field of the Invention

The invention lies in the field of signal processing and memory technology. More specifically, the invention, relates to a method for processing data in a memory. The data are thereby processed according to a predetermined first access strategy in the memory unit and a check is made whether the processing of the data can be better executed using a different predetermined access strategy. The invention further pertains to a device for processing data in a memory unit. The device includes a microprocessor, a control unit, and a memory controller. The control unit and the memory controller are connected with the microprocessor via a first interface. The memory controller processes data according to a predetermined first access strategy in the memory unit and the control unit checks whether the processing of the data can be executed better, preferably faster, using a different access strategy.

Data are read out from a memory by a memory controller via a predetermined access strategy. Given a semiconductor memory unit having a matrix-type construction, the access strategy is defined, for example through a wiring or a fixedly programmed register in such a way that after the writing or reading of a datum, the access line remains controlled to a column of the memory, and after a change of the column to be processed the access line is no longer controlled, and subsequently current flows through the access line of the new column to be read out. In this way, the memory controller is committed to and configured for an access strategy.

### Summary of the Invention

The object of the present invention is to provide a method of processing data in a memory which overcomes the above-noted deficiencies and disadvantages of the prior art devices and methods of this general kind, and which provides for a more flexible method and a more flexible device for processing data in a memory unit.

With the above and other objects in view there is provided, in accordance with the invention, a method of processing data in a memory, which comprises:

processing data according to a predetermined first access strategy in the memory unit;

calculating or emulating a second access strategy in real time with the first access strategy; and comparing the access strategies and checking whether data processing can be better executed using the second access strategy.

In accordance with an added feature of the invention, the worse of the two access strategies is written to a list, and the access strategies in the list are no longer utilized in the calculating or emulating step. In this preferred specific embodiment, the access strategy recognized as being slower is written into a table, and the access strategies contained in the table are not used for a further comparison.

In accordance with another feature of the invention, the method further comprises reading, at predeterminable times, a new access strategy from a memory, and performing the comparing and checking step with the new access strategy.

In accordance with an additional feature of the invention, processing data includes reading out and writing data to the memory unit.

In accordance with a further feature of the invention, a variety of processing types are executed, and storing in a memory unit a respective access strategy, for at least some of the processing types, according to which processing type is carried out.

In accordance with again an added feature of the invention, the memory unit has a plurality of control lines and the various access strategies differ in the type of controlling the control lines of the memory unit.

In accordance with again an additional feature of the invention, the step of processing data includes converting predetermined memory addresses into physical memory addresses.

In accordance with again another feature of the invention, the comparison is performed over a relatively large number of processing cycles and, in a preferred mode, the better access strategy is defined as representing faster processing.

With the above and other objects in view there is provided, in accordance with the invention, a device for processing data in a memory unit, comprising:

a microprocessor and a first interface connected to the microprocessor;

a control unit connected to the microprocessor via the first interface;

a memory controller connected to the microprocessor via the first interface, the memory controller processing data in the memory unit according to a predetermined first access strategy;

the control unit checking whether processing of the data can be executed better (e.g., faster) using a different access strategy, wherein the control unit emulates the processing of the data according to a second access strategy, and the control unit determining which access strategy allows for better processing of the data.

In accordance with yet an added feature of the invention, the control unit is configured to identify for the memory controller the better access strategy for further processing of data.

In accordance with yet another feature of the invention, a memory unit is connected to the control device, for storing access strategies.

In accordance with a concomitant feature of the invention, a memory unit stores different access strategies for different types of processing, and the memory controller is configured to utilize the different access strategies in executing various types of processing.

An advantage of the invention is that the processing of data in the memory unit using a second access strategy is checked [or: monitored], and the access strategy with which the data are processed better, preferably faster, is used for a further processing of data in the memory unit.

The second access strategy is thereby emulated in real time with the first access strategy, and in this way a precise comparison between the first and the second access strategy is obtained.

Preferably, at predeterminable times a new access strategy is read out from a memory unit and is tested as a new second access strategy. In this way, a running adaptation to an optimal access strategy is enabled.

In a preferred specific embodiment, a second control device is provided that is connected with a memory controller that controls the processing of the data in the memory unit. The second control unit emulates a processing of the data in the memory according to a second access strategy. Through the use of a second control unit, an emulation of the second access strategy in real time is advantageously possible.

Other features which are considered as characteristic for the invention are set forth in the appended claims.

Although the invention is illustrated and described herein as embodied in a method and device for processing data in a memory unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a schematic design of a computing unit;

FIG. 2 is a block diagram showing a matrix-type memory unit;

FIG. 3 is a flow chart illustrating a method sequence according to the invention;

FIG. 4 is a schematic block diagram listing a memory unit; and

FIG. 5 is a clocking timing sequence diagram.

### DESCRIPTION OF THE PREFERRED EMBODIMENTS

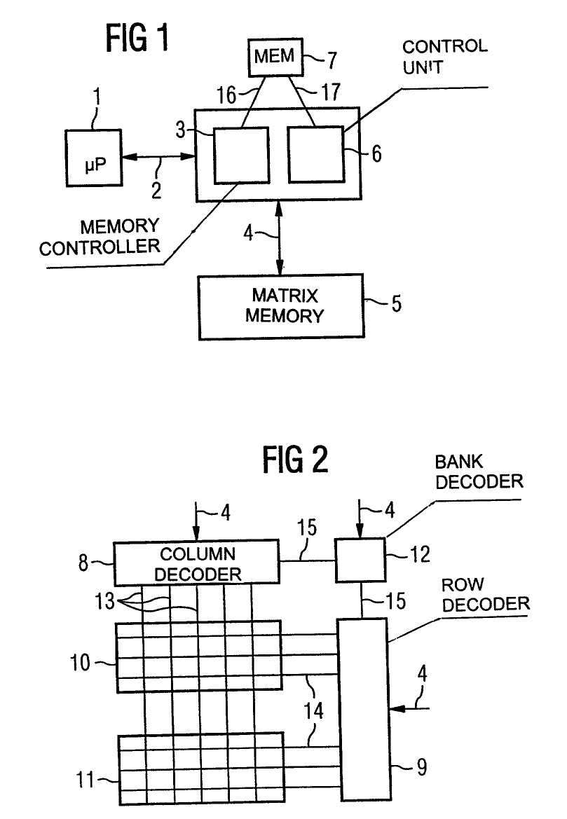

Referring now to the figures of the drawing in detail and first, particularly, to FIG. 1 thereof, there is seen a microprocessor 1 (labeled, for short, μP) that is connected with a memory controller 3 via a first interface 2. The memory controller 3 is connected with a matrix-type memory unit 5 via a second interface 4. In addition, a control unit 6 is provided that is connected to the second interface 4.

In addition, a second memory unit 7 (labeled, for short, MEM) is provided that is connected with the memory controller 3 and with the control unit 6 via first and second data lines 16, 17, respectively.

In the second memory unit 7, the program steps are stored according to which the memory controller 3 processes data in the memory unit 5 according to a request from the microprocessor 1. Here, the processing of data in the memory unit 5 is understood to include the writing of data, the reading out of data, erasing of data, copying of data. That is, any and all processing of data in the memory unit 5. In addition, additional access strategies for processing data in the memory unit 5 are stored in the second memory unit 7.

FIG. 2 schematically shows the design of memory unit 5, having a column decoder 8, a row decoder 9, and memory banks 10, 11. In addition, memory unit 5 includes a bank decoder 12 that is connected with column decoder 8 and with row decoder 9 via bank lines 15. The column decoder is connected with first and second memory bank 10, 11 via column lines 13. Row decoder 9 is connected with first and with second memory bank 10, 11 via row lines 14. Memory banks 10, 11 comprise memory cells that are respectively connected with a column lines 13 and with a row line 14, that is, the memory cells are located at intersection points of the columns and rows. In addition, row decoder 9 is fashioned in such a way that it respectively controls a first, second, or third row line 14 of first and of second memory bank 10, 11. Via bank decoder 12, it is defined wherein memory bank a column line 13 and a row line 14 are controlled.

Memory banks 10, 11 are for example constructed as DRAMs. A DRAM is wherein in it is controlled with a row address and a column address. For an access, first a row is “opened,” and then the corresponding column on the opened row is given out. When a row (also called a page) is opened, the entire row (i.e., all associated columns) is written into a fast SRAM intermediate or buffer memory, called the Sense Amps. In modern memory units, the access to an additional column of the opened row (page) is faster, because the row need no longer be opened (fast page mode). The slow opening is omitted. Memory banks are memory matrices that are independent of one another; i.e., if in a system there is a plurality of memory banks, then it is possible in each memory bank to open an arbitrary page (row), and in this way, given n memory banks, n different pages can be kept open.

If a microprocessor needs some datum or other from a memory unit, it requests a physical address via its system bus. In modern processors, this address is not multiplexed as a complete address (e.g., 32-bit address). The memory controller must now convert the physical address into a multiplex access to the memory unit (bank, row, column address), i.e., the controller must typically open a row in a bank and then read out the desired column. Given a further access to this bank with an opened bank, there are two possibilities:

a) The required address is on the same page (page hit); in this case, the time-consuming opening of the page is omitted and the memory access is very fast.

b) The required address is on another page (page miss); in this case, the opened incorrect page must first be closed (pre-charge command, in a DRAM), and then the desired correct page must be opened (activity command), and then the required column is read (READ or WRITE).

The third possibility that can occur is the possibility that no page is open (close page hit); in that case, the pre-charge command (closing of the page) is omitted. One possible access strategy is that the last-read page is always left open. A further access strategy is that the page is always closed after each access. In addition, whether the page is closed or not can also be made dependent on the address region.

In the following, an overview of the functioning of the configurations of FIGS. 1 and 2 is given:

If microprocessor 1 is processing a program (a task), it requests a large number of data from the memory controller. Memory controller 3 retrieves from second memory unit 7, e.g. at the start of a program, the access strategy with which the requested data are read out from memory unit 5. Subsequently, according to the access strategy predetermined by second memory unit 7, memory controller 3 retrieves the requested datum via a corresponding controlling of the column decoder, row decoder, and bank decoder 8, 9, 12 from the corresponding memory cell. Subsequently, memory controller 3 outputs the read-out datum to microprocessor 1 via first interface 2. If a datum is to be written to a memory cell of memory unit 5, memory controller 3 writes the datum predetermined by microprocessor 1 into the corresponding memory cell of memory unit 5. The access strategy predetermined by second memory unit 7 is used both during the reading out and also during the writing.

Control unit 6 is connected to first and second interface 2, 4. In this way, control unit 6 monitors the exchange of data of memory controller 3 with microprocessor 1 and with memory unit 5. In this way, control unit 6 acquires the access strategy executed by memory controller 3, and at the same time acquires the time that memory controller 3 requires in order to process data in memory unit 5. Control unit 6 stores the time required by memory controller 3 for the execution of a task predetermined by microprocessor 1 in second memory unit 7. Further access strategies with which data in memory unit 5 can be processed are stored in second memory unit 7. In addition, the times required by the various access strategies and various programs (tasks) for the processing of data in memory unit 5 are preferably stored in second memory unit 7. In a preferred specific embodiment, control device 6 simulates the processing of the data in memory unit 5 that memory controller 3 executes, using a second access strategy. Control device 6 determines the time required for the processing of the data with the second access strategy, and compares this time with the time required by memory controller 3 using the first access strategy. Memory controller 3 preferably uses the faster access strategy for the further processing of the data.

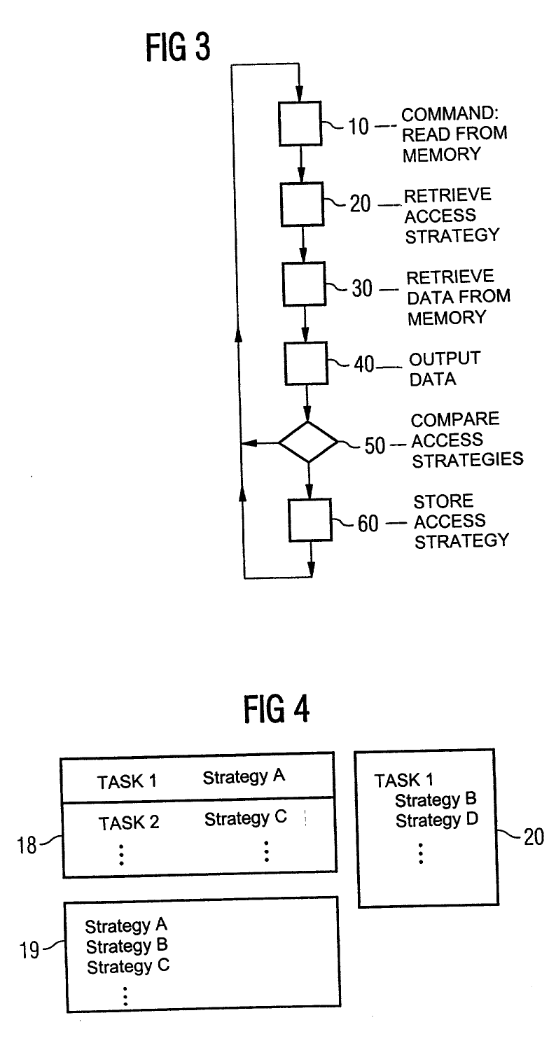

A detailed description of the functioning of the invention is explained in more detail on the basis of the program sequence of FIG. 3. At program point 10, microprocessor 1 gives memory controller 3 the task of reading out a datum from address a of memory unit 5. At program point 20, memory controller 3 retrieves from second memory unit 7 an access strategy defined for the predetermined task, designated in the following as the first access strategy. Subsequently, during the processing of the task, at program point 30 memory controller 3 retrieves the data from memory unit 5 according to the first access strategy. For this purpose, memory controller 3 converts address a of microprocessor 1 into a physical address x₁, y₁. For this purpose, column decoder 8, row decoder 9, and bank decoder 12 are controlled in the manner determined by the first access strategy. According to the access strategy, memory controller 3 allocates a different bank address, column address, or row address to an address location, for example the 32-bit-long address of the microcontroller (address mapping). Subsequently, at program point 40 memory controller 3 outputs the datum of address x, y to microprocessor 1 via first interface 2.

At program point 20, control unit 6 simultaneously processes the task that the microprocessor is processing. Chronologically parallel to the processing of program points 20 to 40, control unit 6 calculates the time that is required for the task if the task is read out from memory unit 5 according to a second access strategy. The second access strategy is stored in second memory unit 7, and was read out from second memory unit 7 by control unit 6. Control unit 6 uses various strategies for converting an address a of microprocessor 1, and thus determines addresses x₂, Y₂ in memory unit 5. At the same time, control unit 6 measures the time that memory controller 3 requires for the processing of the task predetermined by microprocessor 1 according to the first access strategy. The required time is preferably averaged over a multiplicity of data accesses to memory unit 5.

At the following program point 50, control unit 6 compares the time required by memory controller 3 for the processing of the task with the time calculated by control unit 6 for the processing of the task according to the second access strategy. If the comparison at program point 50 yields the result that the second access strategy enables the processing of the task in a shorter time, at program point 60 the second access strategy is stored in second program memory unit 7 by control unit 6 as the access strategy used in the future by memory controller 3 in the processing of the corresponding task. The slower, first access strategy is stored in second program memory unit 7 in an exclusion list, with the indication of the task for which the access strategies were compared.

If the query at program point 50 yields the result that the task predetermined by microprocessor 1 can be processed faster using the first access strategy than with the second access strategy, the predetermination of the first access strategy for the predetermined task remains stored in unmodified form in second program memory unit 7,. A branching back to program point 10 subsequently takes place. Instead of speed, other characteristics, such as for example power consumption, can be monitored, and the access strategy can be selected that enables better processing of the task with regard to the monitored characteristic.

An exemplary embodiment of the invention has been explained in relation to the task of reading out a datum. However, microprocessor 1 can also predetermine additional tasks, such as e.g. writing a datum to a predetermined memory address, or copying a datum from a first memory address into a second memory address, or erasing a datum at a predetermined memory address. The enumeration of the tasks is not exhaustive, and can relate to arbitrary operations in memory unit 5, according to the case of application.

The access strategies that are stored in second program memory unit 7 differ for example in that after each reading out of a datum from a memory address, the corresponding bank line 15 and the corresponding row line 14 continue to carry current. The row line opens a selection transistor and begins to read out the stored information, whereby the stored information can be called only after the selection of the column line. Another access strategy is for example that after the reading out of a datum from a memory address, the corresponding bank line 15, the corresponding column line 13, and the corresponding row line are no longer controlled. In this access strategy, the column line, the row line, and the bank line are again controlled only when a corresponding task is predetermined by microprocessor 1. In contrast to this, the first access strategy has the advantage that, given the same bank address and the same row address, only the corresponding column line need be additionally activated in order to enable a datum to be read out. However, if the bank address and the row address also change, first the previous bank line and the previous row line must be switched off, and a new bank line and a new row line must be controlled. Thus, the various access strategies have advantages or disadvantages according to the type of successive accesses to the memory cells of memory unit 5. If, for example, data having predominantly the same bank address and the same row address are read in or out, the first access strategy is faster. If, however, data having different bank and row addresses are often read in or out successively, the second access strategy is faster. In principle, the speed of an access strategy is determined over a large number of accesses, and thus represents a statistical average of the speed with which microprocessor 1 obtains data from memory controller 3.

An essential core of the invention is that the access strategy used by memory controller 3 is adapted to the type of tasks given to memory controller 3 by microprocessor 1. In this way, an optimization of the access strategy to the tasks to be executed is possible. Thus, there is an overall improvement of the processing of data in memory unit 5 and the processing of tasks in microprocessor 1.

As an additional access strategy, for example a different arrangement of the data in the memory unit can be carried out. Microprocessor 1 indicates a memory address that is converted into a physical memory address by the row decoder and the column decoder. According to the case of application, it can be advantageous to arrange memory addresses that are often predetermined successively by microprocessor 1 physically on a row line. This offers the advantage that, given successive queries of the data, the row line can remain controlled, and only the column line need be altered. In this way, a faster reading out of the data is possible.

A large number of access strategies are possible that can be selected in a corresponding manner by someone skilled in the art.

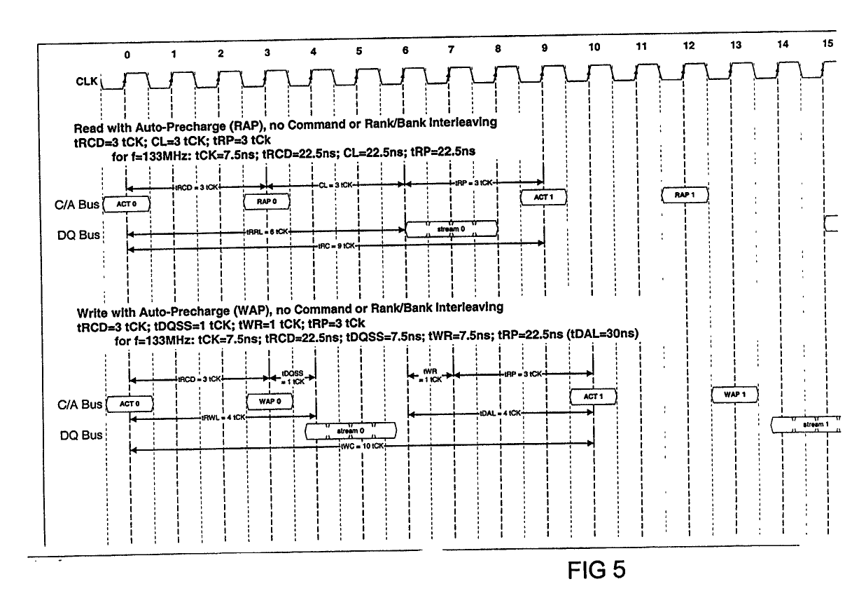

FIG. 4 shows a first, second, and third list 18, 19, 20, that are stored in second program memory unit 7. In the first list 18, an access strategy is allocated to various tasks. If, for example, memory controller 3 must process task 1, strategy A is given to this controller as an access strategy. If memory controller 3 must execute task 2, strategy C is given to it as an access strategy. As described above, the allocation of the tasks to the access strategies can be changed by control unit 6. In this way, a running adaptation of the optimal access strategy is possible.

In the second list 19, various access strategies A, B, C, etc., are stored, from which control unit 6 selects an access strategy in order to carry out a comparison calculation for the determination of the time or of the power consumption required for the processing of a predetermined task.

In a preferred specific embodiment, control unit 6 statistically accesses the strategies stored in second list 19 at predetermined times, and, parallel to a task predetermined by microprocessor 1, calculates the time or the power consumption for the execution of the task according to the selected access strategy.

In a preferred specific embodiment of the invention, for each task predetermined by microprocessor 1 a third list 20 is stored in second program memory unit 7, wherein the access strategies are stored that control unit 6 has already recognized as being worse for a particular task. The third list 20 represents an exclusion list that has the advantage that control unit 6 does not always monitor all possible access strategies of second list 19, but rather checks only the access strategies of second list 19 for the predetermined task that are not stored in a third list 20 for the corresponding task. In this way, an efficient selection of the optimal access strategy is made possible.

Preferably, the comparison calculation of control unit 6 is executed in real time, parallel to the execution of the task by memory controller 3. In a preferred specific embodiment, an access strategy determined as a better access strategy by control unit 6 is not used by memory controller 3 until there is a new system start or program start.

The invention has been explained in relation to the example wherein the access strategies are checked with reference to speed. The comparison of the access strategies can however also be carried out with respect to other results. For example, that access strategy that results in a lower heating or a lower power consumption of memory unit 5 can be sought as the better access strategy.

In a preferred specific embodiment, control unit 6 is connected only to first interface 2, and acquires the tasks that are predetermined to memory controller 3 for execution. Control unit 6 measures the time required by memory controller 3 for the execution of the tasks. In addition, given known execution times, control unit 6 calculates the time that would be required for the execution of the tasks using a different access strategy. In a development, control unit 6 simulates the time that would be required for the execution of the tasks using another access strategy.

In the monitoring of the execution of the tasks, in a preferred specific embodiment control unit 6 executes the tasks in a selected access strategy; i.e., control unit 6 processes data in memory unit 5 and/or converts the addresses predetermined by the microprocessor into physical addresses, with a controlling of bank decoder 12, column decoder 13, and row decoder 14. At the same time, control unit 6 measures the time required for the execution of the tasks. Subsequently, control unit 6 compares the time that was required by memory controller 3 for the execution of the task using the first access strategy with the time required by control unit 6 for the execution of the task using the selected access strategy.

FIG. 5 shows an exemplary embodiment. The following abbreviations are used:

| | |
|---|---|
| ACT | command for the opening of a bank in a DRAM (activate). |
| RAP | command for reading data with subsequent automatic |
| | closing of the bank from which reading takes place (read |
| | auto precharge). |
| WAP | command for writing data with subsequent automatic |
| | closing of the bank to which writing takes place (write |
| | auto precharge). |
| tRCD | delay time that must be present between an ACT command |
| | and a RAP command, or between an ACT command and a WAP |
| | command. |
| CL | time that passes between the sending of the RAP command |
| | and the reception of the data that are read out from the |
| | DRAM. |
| BL | number of data words that are transmitted with a single |
| | read or write command (burst length). |
| tRP | time required for the closing of a bank (row precharge). |
| tDQSS | time that passes between the sending of the WAP command |
| | and the sending of the data that are to be written into |
| | the DRAM. |
| tWR | time that passes in order for the DRAM to transfer the |
| | data that are to be written from the interface into the |
| | memory cell field (write recovery). |
| tDAL | = tWR + tRP: time that passes in order for the DRAM to |
| | transfer the data that are to be written from the |
| | interface into the memory cell field, and subsequently |
| | to close the bank to which writing takes place. |
| tRRL | = tRCD + CL: time that passes between the sending of the |
| | ACT command and the reception of the data (random read |
| | latency). |
| tRC | = tRCD + CL + tRP: time that is required in order to |
| | process an entire read cycle (read cycle). |
| tRWL | = tRCD + tDQSS: time that passes between the sending of |
| | the ACT command and the sending of the data to the DRAM |
| | (random write latency). |
| tWC | = tRCD + tDQSS + BL/2 + tDAL: time that is required in |
| | order to process an entire write cycle (write cycle). |

### EXAMPLE

It is assumed that the following access strategy is emulated in the “passive emulator” of the memory controller, i.e., in control unit 6:

First, the following task is emulated: “Reading and writing with automatic closing of the bank, without interleaving of the commands or of the banks” (read/write with auto-precharge, no command and/or bank interleaving).

The associated sequences that are required for the reading or writing of data to a memory unit are shown in the accompanying illustration in exemplary fashion for what are known as DDR-DRAMs (Double-Data-Rate DRAMs).

Read: if the memory controller receives a read request, the following individual steps are necessary:

a) Open a particular page in a particular bank in the DRAM from which reading is to take place.

b) Send a read command with the address of the column from which reading is to take place.

c) Wait a determined amount of time until the data from the DRAM can be read into the controller.

d) Wait a determined amount of time until the transmission of data from the DRAM into the controller is completed.

e) Wait a further determined amount of time until the bank in the DRAM from which reading has taken place is again closed.

Write: if the memory controller receives a write request, the following individual steps are necessary:

a) Open a particular page in a particular bank in the DRAM into which writing is to take place.

b) Send a write command with the address of the column to which writing is to take place.

c) Wait a determined amount of time until the data can be sent from the controller to the DRAM.

d) Wait an additional determined amount of time until the transmission of data to the DRAM is completed.

e) Wait an additional determined amount of time until the data have been transmitted from the interface of the DRAM into the DRAM cell field.

f) Wait an additional determined amount of time until the bank in the DRAM to which writing has taken place is again closed.

With the access strategy described here, control unit 6 is therefore able to emulate or to calculate the duration of the individual read or write requests. In the simple access strategy presented here, it is not absolutely required that the read and write accesses actually be emulated in terms of hardware. It would also be possible for control unit 6 simply to assume the following times:

a) Random read latency amounts to tRRL.

b) A complete read cycle lasts tRC.

c) Random write latency amounts to tWRL.

d) A complete write cycle lasts tWC.

However, it is understandable that any access strategy that is somewhat more complex than the one described here can no longer be described easily using four parameters (tRRL, tRC, tRWL, tWC). Examples of more complex access strategies include for example:

the memory banks are not closed immediately after each read or write access, but rather are left open for a determined time with the aid of particular algorithms that are not specified here in more detail (Bank Interleaving).

the commands that relate to various memory banks can be interleaved with one another, so that it is not necessary to wait tRC or tWC until a further access cycle can be started (Command Interleaving).

Since the combinations relating to bank and command interleaving can be formed with almost any degree of complexity, in a second embodiment of control unit 6 it is advantageous to make available the circuit block with which the actual memory accesses are executed. Control unit 6 can then emulate alternative access strategies, which are then compared with the performance values of memory controller 3.

However, it is also possible to implement other access strategies, or new access strategies, which can then be compared with the access strategies of memory controller 3.

An emulation is understood as the imitation of a hardware function through software. In the described exemplary embodiment, the hardware components that are used for reading and/or writing of a datum in the DRAM memory are imitated in the form of software. In this way, a realistic simulation of the functioning of the DRAM memory is possible.

We claim:

1. A method of processing data in a memory, which comprises:
processing data according to a predetermined first access strategy in the memory unit;
calculating or emulating a second access strategy in real time with the first access strategy; and
comparing the access strategies and checking whether data processing can be better executed using the second access strategy.

2. The method according to claim 1, which comprises writing the worse access strategy to a list, and no longer utilizing access strategies in the list in the calculating or emulating step.

3. The method according to claim 1, which further comprises reading, at predeterminable times, a new access strategy from a memory, and performing the comparing and checking step with the new access strategy.

4. The method according to claim 1, wherein the step of processing data is a process step selected from the group consisting of reading out and writing data to the memory unit.

5. The method according to claim 1, which comprises executing a variety of processing types, and storing in a memory unit a respective access strategy, for at least some of the processing types, according to which processing type is carried out.

6. The method according to claim 5, wherein the memory unit has a plurality of control lines and the various access strategies differ in the type of controlling the control lines of the memory unit.

7. The method according to claim 1, wherein the step of processing data includes converting predetermined memory addresses into physical memory addresses.

8. The method according to claim 1, wherein the comparing step is performed over a relatively large number of processing cycles.

9. The method according to claim 8, wherein a better access strategy is defined as representing faster processing.

10. A device for processing data in a memory unit, comprising:
a microprocessor and a first interface connected to said microprocessor;
a control unit connected to said microprocessor via said first interface;
a memory controller connected to said microprocessor via said first interface, said memory controller processing data in the memory unit according to a predetermined first access strategy;
said control unit checking whether processing of the data can be executed better using a different access strategy, wherein said control unit emulates the processing of the data according to a second access strategy, and said control unit determining which access strategy allows for better processing of the data.

11. The device according to claim 10, wherein better execution is defined as faster execution.

12. The device according to claim 10, wherein said control unit is configured to identify for said memory controller the better access strategy for further processing of data.

13. The device according to claim 10, which comprises a memory unit connected to said control device, for storing access strategies.

14. The device according to claim 10, which comprises a memory unit storing different access strategies for different types of processing, and said memory controller is configured to utilize the different access strategies in executing various types of processing.
